(19) United States
(12) Patent Application Publication
(10) Pub. No.: US 2025/0349134 A1
(43) Pub. Date: Nov. 13, 2025

(54) SURVEILLANCE DETECTION SYSTEM AND METHOD FOR USING THE SAME

(71) Applicant: AMETOS TECH INC., Country of Kent, DE (US)

(72) Inventors: Nir SOLOVEY, Rishon LeTsiyon (IL); Yaniv EISENMAN, Rishon LeTsiyon (IL); Omer LEV-RON, Rishon LeTsiyon (IL)

(73) Assignee: AMETOS TECH INC., Country of Kent, DE (US)

(21) Appl. No.: 18/860,924

(22) PCT Filed: Apr. 28, 2023
(86) PCT No.: PCT/IL2023/050435

§ 371 Date: Oct. 28, 2024

Related U.S. Application Data
(60) Provisional application No. 63/335,732, filed on Apr. 28, 2022.

(51) Int. Cl. G06V 20/62; G06V 20/52; G06V 30/14

(52) U.S. Cl. CPC G06V 20/625; G06V 20/52; G06V 30/14

(57) ABSTRACT

A method of evaluating a level of suspicion that a vehicle is used for surveillance, the method comprises: collecting images from cameras; identifying license plate characters from the collected images; checking if the license plate satisfies a predefined rule; assigning a score to the license plate based on a rule that the license plate satisfies; determining a level of suspicion that the vehicle is used for surveillance of a specific object based on the score of the license plate.

### FIELD OF THE INVENTION

The present invention relates to surveillance systems.

### BACKGROUND OF THE INVENTION

Surveillance detection is needed by persona and/or organizations wishing to know whether or not they are under surveillance. Surveillance detection systems may be installed near persons' residents, to identify persons surveying nearby. Surveillance detection is more complicated in mobile environments, such as detecting whether or not a vehicle is under surveillance or a person is under surveillance by vehicles.

Identifying vehicles used for surveillance is complicated as operators and drivers of these vehicles use techniques to avoid detection, such as changing a distance between the surveillance vehicle and the target, switching vehicles used for surveillance over time and additional techniques. In addition, the number of experts who can detect surveillance is limited, as the knowledge and experience is mostly gained at elite intelligence units. Further, many times the target is alone in the vehicle, driving, and the target's attention should be on the road, not on identifying surveillance vehicles. In view of the above, there is a need for a technological system for identifying surveillance vehicles.

### SUMMARY OF THE INVENTION

It is an object of the subject matter to disclose a A method of evaluating a level of suspicion that a vehicle is used for surveillance, the method comprises: collecting images from cameras; identifying license plate characters from the collected images; checking if the license plate satisfies a predefined rule; assigning a score to the license plate based on a rule that the license plate satisfies; determining a level of suspicion that the vehicle is used for surveillance of a specific object based on the score of the license plate.

In some cases, the cameras are installed on mobile objects. In some cases, the cameras are installed on static agents. In some cases, the images are part of a video stream. In some cases, the characters include letters and numbers.

In some cases, the identification comprises using optical character recognition (OCR) techniques. In some cases, the output of the identifying process is a string of characters normally used in a language used by the relevant jurisdiction.

In some cases, determining the level of suspicion comprises assigning a specific customer with a specific group, the specific group represents a likelihood that the specific customer is under surveillance.

In some cases, the method further comprises identifying an anomaly event of the license plate and changing a score of the license plate according to the anomaly event. In some cases, the method further comprises increasing an anomaly detection counter of the license plate. In some cases, the anomaly detection counter represents a number of times the license plate was recognized on a specific time frame.

In some cases, the anomaly event is identified according to a timing of identifying the license plate and a number of appearances of the license plate in a session. In some cases, determining a level of suspicion that a vehicle is used for surveillance of a first object is based on the score of multiple license plates identified from the collected images.

In some cases, the method further comprises storing multiple lists, each list is associated with another object and includes one or more license plates having a suspicion level of surveillance of each object. In some cases, the method further comprises classifying a level of suspicion of a vehicle based on list types, wherein the vehicle can be assigned a new list based on changes in the score. In some cases, the number of rules applied on a specific license plate in a given day is limited.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 shows a method of evaluating a financial risk of a specific organization due to potential security events, according to an exemplary embodiment of the present invention;

FIG. 2 shows a method of evaluating a level of suspicion that a vehicle is used for surveillance, according to an exemplary embodiment of the present invention;

FIGS. 3A-3B show a device for storing and carrying cameras, according to exemplary embodiments of the subject matter;

FIG. 4 shows an exploded view of the device, according to exemplary embodiments of the subject matter;

FIG. 5 shows an exploded view of a camera housing and a housing mount, according to an exemplary embodiment of the present invention.

### DETAILED DESCRIPTION OF THE INVENTION

The subject matter discloses systems and processes for counter-surveillance (anti-tracking) applications, in which an entity wishes to identify and evaluate whether or not it is being surveyed. The processes receive images and/or video streams from cameras to determine if there is a surveillance vehicle within the field of vision (FoV) of the camera. The process may output an indication of covert surveillance being taken against the user.

The system may have a static mode and a dynamic mode. The static mode is designed for buildings and other objects secured to a specific place, such as houses, offices, homes, secured properties, campuses, etc. The dynamic mode is designed to be mounted on vehicles or other moving objects. The two modes can work separately or together.

The system comprises several components as elaborated below. The system comprises one or more cameras and/or laser sensors, installed on static objects or on mobile objects such as vehicles. The system also comprises an identifying module for identifying a license plate, an individual, or an object from the images. The identification may be done using known processes and techniques, such as OCR, pattern recognition, and the like. The system may also comprise a database for storing events in which specific license plates, individuals or objects were identified and rules for processing the events to output indications on the likelihood that the entity is under surveillance. The entity may be a person, a group of persons, a building, a vehicle, goods, such as jewelry, a briefcase containing documents, an electronic device, and the like.

The system may comprise a user interface enabling users to log in and interact with the system, for example, to view information concerning the license plates, update rules for providing the indications, and the like.

The system may use means to identify the location of the cameras to associate a location to an image that contains a specific license plate. The means may be a GPS Receiver coupled to the cameras or to a device coupled to the cameras. The GPS receiver may be used to receive GPS coordinates in the dynamic mode.

The subject matter discloses scoring processes for scoring license plates of vehicles. The scoring processes enable to output a level of suspicion of vehicles, said level indicates the likelihood that the vehicle is used to survey the entity. The scoring processes use a set of rules to output the level of suspicion, as elaborated below, based on images collected by the cameras. The scoring processes may be used in either the dynamic mode or in the static mode.

In some exemplary embodiments, the license plate may be assigned a label, or be included in a group based on the level of suspicion, as follows: 1. Unclassified or suspicious plates are stored in a grey list. 2. Known or trustful plates (vehicles) are stored in the white list. 3. Adversary/surveillance plates are stored in the blacklist. Other processes in the scope of the subject matter may use a different number of groups.

The lists, processes, and suspicion levels may be outputted for a single entity. For example, the system may have 200 separate customers, and collect images sent to a central server that serves more than a single customer. The server stores the lists, which may be unique to each customer. That is, a vehicle may be on the black list for customer #2 and be in the white list for customers #3-#200.

Each plate that was recognized for the first time, creates a new Alert Definition with an initial score of zero (0). Each Rule in the system has a field called weight, which represents how much this rule affects the score of the plate. The score can be increased only by a rule which was triggered, and therefore the rule's weight (integer) will be added to the plate's score.

The alert definition's suspicion status may be represented using the following colors:
None—No color indicates a new unknown license plate in the system. This color label doesn't trigger an alert.
Blue—A blue alert indicates an abnormal vehicle behavior—lowest severity alerts (notice alert).
Orange—An orange alert indicates a suspicious license plate—middle severity alert.
Red—A red alert indicates a surveillance license plate—highest severity alert.

The alert color will be determined by a score that the license plate will receive. A score will vary from 0 to 15, as shown below:
0—None
1-7—Blue
8-14—Orange
15—Red

The values may change from time to time. When the score reaches Red values, an alert may be sent to an address or a device inputted by the customer, such as a phone, email address and the like.

The score can be increased or decreased by a rule which was triggered. Each rule will have a “weight”, which represents how much this rule affects the plate's score. Alerts are stored in the management database and hold license plate alert details.

The rules may include comparing a timestamp and location of detection of a license plate to a prior detection of the same license plate. For example, in case the last detection of the same license plate occurred less than a predefined number of minutes before the current detection of the same license plate, the license plate's score will increase by 3 points. Similarly, in case the last detection of the same license plate occurred less than a predefined number of meters before the current detection of the same license plate, the license plate's score will increase by 2 points. A combination of distance and time being less than a threshold may result in increasing the license plate's score will increase by 6 points.

The system may comprise multiple agents, installed on movable objects or on static objects. The agents may be assigned to groups, for example, based on customer, business field, geographic location, and the like. Another rule that may change a license plate's score is when the same license plate is detected by two different cameras of the same group in a single time frame, such as a week/day/3 hours.

In case a license plate is recognized by a static agent and the same plate was previously recognized by another static agent in the same agent's group, and there is no previous alert about the specific license plate from the current agent, the license plate's score may be increased. Another rule may relate to the difference between the number of appearances of a specific license plate during a recognition session (for example within an hour) and the number of appearances of the same license plate's in a previous session being bigger than a threshold.

Another rule used to adjust the score may be when a license plate is recognized by a dynamic agent or static agent and the same plate was previously recognized by a static agent/dynamic agent in the same agent's group.

In some cases, the number of rules applied on a specific license plate in a given day is limited, for example to 3 rules, or to a specific combination, such as only if rules #1, #4, and #12 are triggered in a given day, additional rules can be triggered for the license plate.

Another rule may be applied when a license plate is recognized by a dynamic agent and the same license plate was previously recognized by another dynamic agent used by or allocated to the same customer of the system.

Another rule may be used in case the difference between the number of appearances of a license plate in the current recognition session and the number of appearances the same license plate was recognized in a previous recognition session when a rule was triggered for the same plate, is larger than a threshold.

Another rule may be applied when a license plate is recognized by a static agent, the same license plate was previously recognized by a static agent or dynamic agent used by or allocated to the same customer of the system.

Another rule may be used to decrease points from a license plate's score, for example in case a specific license plate was not recognized for a period of time larger than a threshold, such as 30 minutes, 12 hours or 4 days. Score decrease may be determined when a license plate is detected, and the same plate was previously recognized by a static agent or dynamic agent used by or allocated to the same customer of the system and the plate wasn't seen for a time period larger than the threshold. The plate may be on the blacklist or in another list that is not the white list.

Another rule that may be used is a case in which a license plate recognized by static agent and the same license plate was recognized in the past by the same static agent, and the number of times the license plate was recognized in a recognition session is higher than a threshold, such as 20 or 50 times.

In some cases, the method of the subject matter comprises monitoring an anomaly counter, which is a value to count the number of consecutive times that any rule was triggered for a given license plate. For example, vehicle A was recognized 4 times and triggered a rule each time it was recognized. In such case, its anomaly counter value will be 4. If the next time vehicle A was recognized didn't trigger any rule, the anomaly counter will be reset to zero. Any additional anomaly may result in adding a point to the license plate's score.

Another exemplary rule may be applied in case a license plate is recognized by static agent and the same license plate has triggered a rule related to the static agent and another plate has triggered a rule related to the same static agent in the during a period of time lower than a threshold, for example less than 15 minutes. In such case, both vehicles' scores will be increased.

When a dynamic agent is turned on, a new ride for the vehicle to which the agent is coupled starts. In such case, the turns count may be reset to zero (0). The mobile agent may have sensors, such as a GPS receiver or an accelerometer, configured to count the number of turns during the ride. From the beginning of a drive until the end, if the same license plate has been seen again by 7 the same dynamic agent, and if the number of turns the vehicle made between the latest plate appearance to its first appearance is bigger than a threshold (the threshold Is a numeric parameter), a rule will be triggered.

Another exemplary rule may be applied when a license plate recognized by static agent and the same plate was previously recognized by the same static agent the time interval of the recognitions is between the period limits, for example 2-10 minutes.

Another exemplary rule may be applied when a license plate is recognized by a dynamic agent. In case the same license plate was previously recognized by the same dynamic agent and the most recent recognition occurred within a time threshold, for example 2 hours prior to the new detection during a different previous ride, the license plate's score will be increased.

The same rules can be used for the detection, recognition and scoring of individuals using face recognition processes. The same rules can also be used for the detection, recognition and scoring of objects with a unique identifier, using WiFi signals, Bluetooth signals and/or phone signals to sniff WiFi/Bluetooth/RF signals and detect unique identifiers in these signals.

The system uses technical processes to take the rules described herein and apply them to the detection, recognition and scoring of license plates, individuals and objects with a unique identifier. The system also uses machine learning processes to identify behavioral patterns in the detection, recognition and scoring of license plates, individuals and objects with a unique identifier.

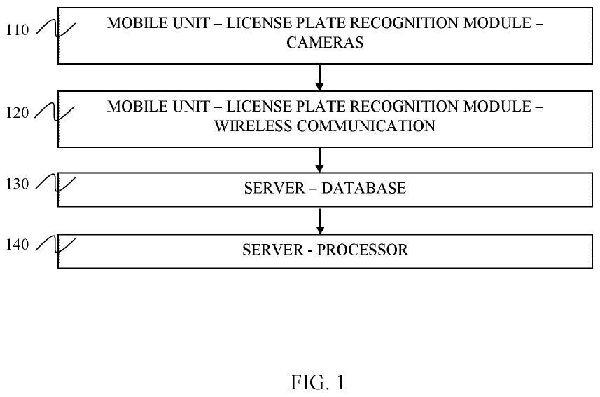

FIG. 1 shows a method of evaluating a financial risk of a specific organization due to potential security events, according to an exemplary embodiment of the present invention. The system comprises one or more cameras 110. The cameras 110 may be located on a movable object, such as a vehicle, animal, drone and the like. The cameras 110 may be coupled to a static object, such as a building, a tree, a traffic light and the like. The cameras 110 may receive electronic power from a battery, or from a vehicle's power system. The cameras may capture images on a sampling frequency defined by the camera's hardware, for example, 24 frames per second. In some cases, the sampling rate may change in view of an event, for example identifying a license plate having a score higher than a threshold. The event may be defined by the vehicle's velocity, vehicle's location and the like.

The system also comprises one or more sensors to detect and identify objects through laser beam sensor measurement tools.

The system may comprise a wireless communication module 120 for outputting information from the mobile agent comprising the camera 110. The information may be the images captured by the camera or object recognition processes performed on the images, such as a number of a license plate. The image processing may be performed at the mobile agent or on a remote device such as a server. The mobile agent may comprise a processor and a memory for storing a set of instructions to be performed by the processor. the instructions may comprise identifying a license plate number from the images, adjusting the angle of the camera relative to the ground, adjusting a sampling rate defining the rate of image capturing by the camera and the like.

The system may comprise a server handling the processes described herein. The server may be coupled to multiple mobile agents, either located on movable objects or static objects. The server may comprise a database 130. The database 130 may store data concerning license plates identified by the cameras, such as the timestamp of the image, location of the camera when capturing the image of the specific license plate, number of times the specific license plate was captured, and the like.

The server also comprises a processor 140 for executing a set of rules disclosed herein. The server may be implemented as a virtual machine, or as a web service such as Amazon Web Services.

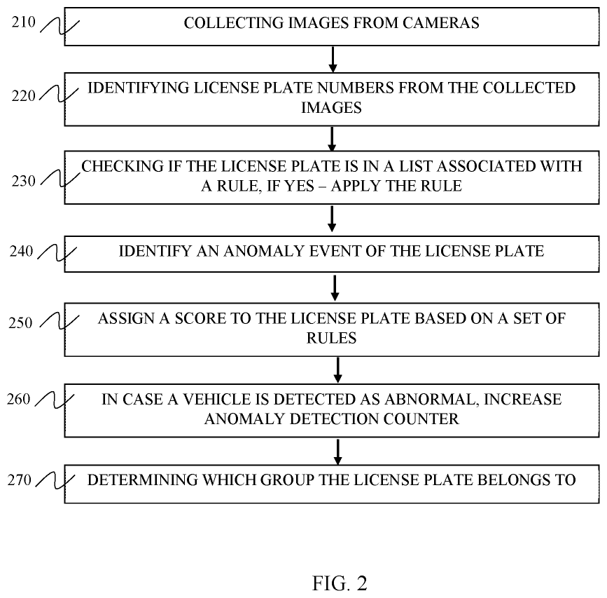

FIG. 2 shows a method of evaluating a level of suspicion that a vehicle is used for surveillance, according to an exemplary embodiment of the present invention.

Step 210 discloses collecting images from cameras and data from sensors. The cameras and sensors may be installed on mobile agents or mobile objects, or on static agents. The images may be part of a video stream. The images and data collected may be stored in a memory coupled to or included in the cameras. The format, resolution, and other properties of the images may be defined by a person skilled in the art.

The cameras and sensors may also be used to detect and identify vehicles with no license plate fixed at the front of the vehicle, and motorcycles, by using processes designed to capture vehicle and helmet identifiers including vehicle make, model and color, and helmet shape and color.

Step 220 discloses identifying license plate numbers from the collected images. The license plates numbers may also include letters and other characters such as “.”, “*”, “*”, and others. The license plate numbers may be identified using a technique defined by a person skilled in the art, such as optical character recognition (OCR), Character segmentation, and the like. The output of this process is a string of characters normally used in a language used by the relevant jurisdiction. The same processes may be applied for the detection, recognition and scoring of individuals and objects with a unique identifier.

Step 230 discloses checking if the license plate is in a list associated with a rule, if yes—apply the rule. This process may be performed at a server storing a list of license plates already recognized from images. Some of the license plates were recognized using images captured by cameras not included in the system, for example using images provided by Google Maps services, or from another third party source.

Step 240 discloses identifying an anomaly event of the license plate. The anomaly event may be stored in a database storing multiple events. The events may be updated frequently. The events may change according to a geolocation, according to a customer of the system, according to additional properties. At least some of the rules are specified above. The rules may refer to timing of identifying the license plate, number of appearances of the license plate in a session, preferences inputted by a customer of the system and the like. Anomaly event may be identified as appearance of the same license plate for over 10 minutes of driving.

Step 250 discloses assigning a score to the license plate based on a set of rules. The score may be unique to a license plate per customer of the system. For example, in case the same license plate was captured by cameras associated with multiple customers of the system, the score will be updated separately, on a per-customer basis. That is, in case the license plate was captured from a static agent while being remote from the customer, this will not have an impact on the license plate's score. The score may be increased in response to identifying an anomaly rule, and decrease over time, in case there is no rule associated with the license plate.

Step 260 discloses in case a vehicle is detected as abnormal, increase the anomaly detection counter. The anomaly detection counter represents the number of times a specific license plate was recognized on a specific time frame, for example, 20 minutes, or during a customer's drive from her office back home.

Step 270 discloses determining which group the license plate belongs to. The group indicates the level of suspicion of the license plate. The group may also indicate the severity of the surveillance of the customer. For example, in case a specific customer is associated with 2 license plates in the Red group, this represents a high likelihood that the customer is under surveillance. In some cases, a specific customer may recognize 5 different license plates on the orange group (8-14 points, for example), which may indicate a specific surveillance technique of using more vehicles.

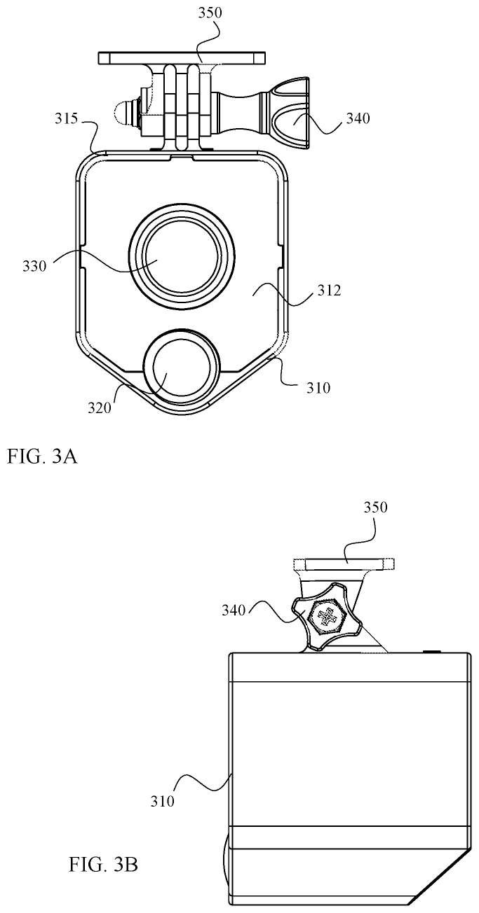

FIGS. 3A-3B show a device for storing and carrying cameras, according to exemplary embodiments of the subject matter. FIG. 3A shows a front view of the housing 310, in which the cameras capture images, while FIG. 3B shows a side view of the housing 310. The device is configured to be secured to a vehicle, to detect surveillance vehicles used to survey the vehicle having the device of the subject matter. The device comprises a housing 310 for storing the cameras and circuitry, such as batteries, control units, memory for storing the captured images, memory for storing rules for operating the cameras, and the like. The housing 310 may be in a polygonal cross-section, such as a rectangle, pentagon, hexagon, octagon, trapezoid, and the like. The housing 310 may be made of a rigid material, such as polymers, metals, and the like. The housing 310 have a front surface 315 configured to be coupled to the mount 350. The mount 350 is configured to secure the housing 310 to the movable object, such as the vehicle's rear window or the vehicle's ceiling.

The housing 310 may store a single or multiple cameras and/or sensors. In the exemplary embodiment of FIGS. 3A-3B, the housing 310 stores a main camera 330 and a secondary camera 320. The effective distance of the main camera 330 may be different from the effective distance of the secondary camera 320. For example, objects captured by the main camera 330 may appear in focus when their distance from the main camera 330 is in the range of 8-10 meters while objects captured by the secondary camera 320 may appear in focus when their distance from the secondary camera 320 is in the range of 2-4 meters.

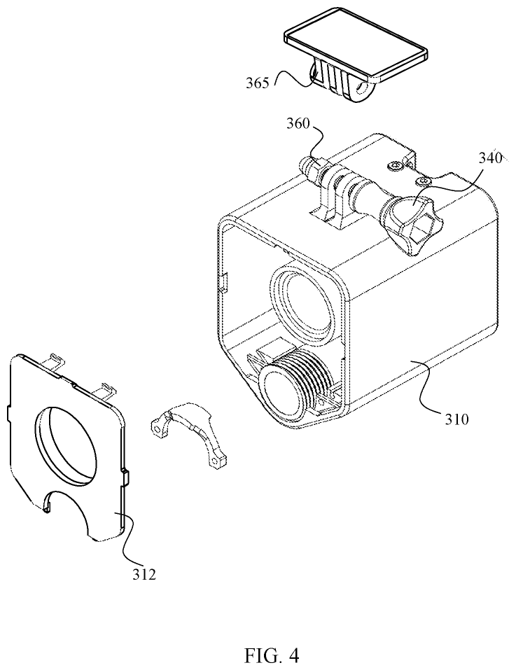

FIG. 4 shows an exploded view of the device, according to exemplary embodiments of the subject matter. The device comprises the housing 310, a front cover 312 configured to secure the cameras and the electrical circuitry while leaving apertures for cameras 320, 330. As such, the front cover 312 may comprise a main hole via which the main camera captures images and a secondary hole via which the main camera captures images.

There is an adjusting mechanism for adjusting an angle between the housing 310 and the mount 350, according to an exemplary embodiment of the present invention. The adjusting mechanism comprises multiple loops 360 forming parallel apertures located in the same plane, enabling insertion of an adjusting pin 340 thereto. The loops 360 may be formed from the same sheet of material as the housing 310, or from a separate sheet secured to the upper surface 315 of the housing 310. The mount 350 is configured to be secured to an object, for example using adhesive materials provided onto a surface of the mount 350. The mount 350 may be coupled to mount loops 365 coupled to the bottom part of the mount 350, as the upper part of the mount 350 is configured to be secured to the surface of the vehicle. The mount loops 365 may be designed in a manner that enables placing the mount loops 365 between loops 360 of the housing 310. This way, the pin 340 can be inserted into both the mount loops 365 and the housing loops 360. One can rotate the pin 340 to adjust the angle between the mount 350 and the housing 310, thereby being able to place the mount on various sloped angles without changing the field of view captured by the cameras 320, 330 placed inside the housing 310.

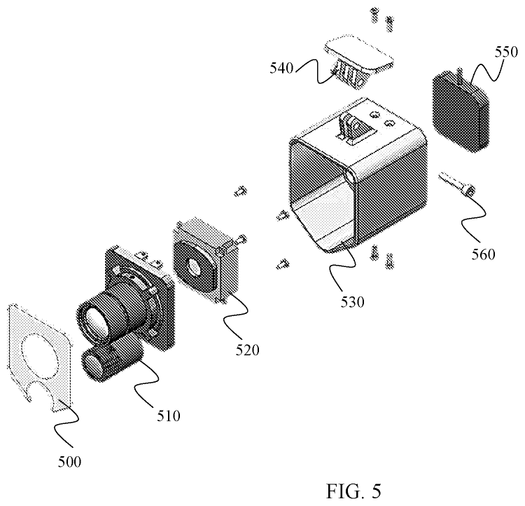

FIG. 5 shows an exploded view of a camera housing and a housing mount, according to an exemplary embodiment of the present invention. The exploded view shows a front cover 500, cameras 510, cameras electrical circuitry 520, housing 530, housing mount 540, GPS receiver 550 and adjusting pin 560 configured to adjust the angle between the housing 530 and the housing mount 540.

While the disclosure has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this invention, but only by the claims that follow.

1. A method of evaluating a level of suspicion that a vehicle is used for surveillance, the method comprises:
collecting images from cameras;
identifying license plate characters from the collected images;
checking if the license plate satisfies a predefined rule;
assigning a score to the license plate based on a rule that the license plate satisfies;
determining a level of suspicion that the vehicle is used for surveillance of a specific object based on the score of the license plate.

2. The method of claim 1, wherein the cameras are installed on mobile objects.

3. The method of claim 1, wherein the cameras are installed on static agents.

4. The method of claim 1, wherein the images are part of a video stream.

5. The method of claim 1, wherein the characters include letters and numbers.

6. The method of claim 1, wherein the identifying comprises using optical character recognition (OCR) techniques.

7. The method of claim 1, wherein an output of the identifying process is a string of characters normally used in a language used by the relevant jurisdiction.

8. The method of claim 1, wherein determining the level of suspicion comprises assigning a specific customer with a specific group, the specific group represents a likelihood that the specific customer is under surveillance.

9. The method of claim 1, further comprises identifying an anomaly event of the license plate and changing a score of the license plate according to the anomaly event.

10. The method of claim 9, further comprises increasing an anomaly detection counter of the license plate.

11. The method of claim 10, wherein the anomaly detection counter represents a number of times the license plate was recognized on a specific time frame.

12. The method of claim 9, wherein the anomaly event is identified according to a timing of identifying the license plate and a number of appearances of the license plate in a session.

13. The method of claim 1, wherein determining a level of suspicion that a vehicle is used for surveillance of a first object is based on the score of multiple license plates identified from the collected images.

14. The method of claim 1, further comprises storing multiple lists, each list is associated with another object and includes one or more license plates having a suspicion level of surveillance of each object.

15. The method of claim 1, further comprises classifying a level of suspicion of a vehicle based on list types, wherein the vehicle can be assigned a new list based on changes in the score.

16. The method of claim 1, wherein a number of rules applied on a specific license plate in a given day is limited.
